(19) United States
(12) Patent Application Publication
(10) Pub. No.: US 2008/0187670 A1
(43) Pub. Date: Aug. 7, 2008

(54) Method for making decoration board

(76) Inventor: Chia Hsin Lee, Caotun Township (TW)

Correspondence Address: CHARLES E. BAXLEY, ESQ., 90 JOHN STREET, THIRD FLOOR, NEW YORK, NY, 10038, US

(21) Appl. No.: 11/704,058

(22) Filed: Feb. 7, 2007

(51) Int. Cl. B05D 3/12

(52) U.S. Cl. 427/376.7

(57) ABSTRACT

A method for making decoration boards includes a step of mixture magnesium chloride and water to form a first mixture; a step of mixing magnesium, the first mixture and water-based foaming agent to form a second mixture which is used as a base; a step of mixing the magnesium and the first mixture to be a third mixture which is coated on the base; a step of molding the base and the top layer in a mold to form patterns in the top layer; a step of drying the molded base and the top layer to combine the molded base and the top layer, the water-based foaming agent being dried by form tiny holes, and a step of coloring the top layer.

### FIELD OF THE INVENTION

The present invention relates to a method for making decoration boards which can be made with desired exterior patterns and are light in weight.

### BACKGROUND OF THE INVENTION

A conventional decoration board for interior or exterior use of buildings generally can be wooden boards which have to be obtained by cutting trees which are precious today. Some decoration boards are made by rocks such as sliced marbles which have natural colors and fixed density. However, to obtain decoration boards of natural rocks require high cost and complicated processes. The rocks have to be cut, ground, polished and long distance of transportation. The rocks are cut into proper sizes so as to be used as decoration boards. The decoration boards are heavy and some are easily broken. When attaching the decoration boards to walls of buildings, cement or adherent are necessary to fix the decoration boards on the building and metal support members are used to further fix the heavy decoration boards. In other words, a high cost is involved when using the decoration boards made by natural rocks.

The present invention intends to provide a method for making decoration boards which are made by water-based foaming agent and mixture of different materials, the water-based foaming agent will be dried so as to form tiny holes in the decoration boards which are light in weight. The surface patterns of the decoration boards can be easily formed by proper molds.

### SUMMARY OF THE INVENTION

The present invention relates to a method for making decoration boards and the method comprises the following steps:

a step of making mixture: mixing magnesium chloride and water to form a first mixture;

a step of making base: mixing magnesium, the first mixture and water-based foaming agent to form a second mixture which is used as a base;

a step of making top layer: mixing the magnesium and the first mixture to be a third mixture which is coated on the base;

a step of molding: molding the base and the top layer in a mold to form patterns in the top layer;

a step of drying: drying the molded base and the top layer to combine the molded base and the top layer, the water-based foaming agent being dried by form tiny holes, and

a step of coloring: coloring the top layer.

The primary object of the present invention is to provide a method for making decoration boards which are light in weight.

Another object of the present invention is to provide a method for making decoration boards and the method is easy and cost for the decoration boards is acceptable.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows steps of the method for making decoration boards of the present invention.

### DETAILED DESCRIPTION OF THE PREFERRED EMBODIMENT

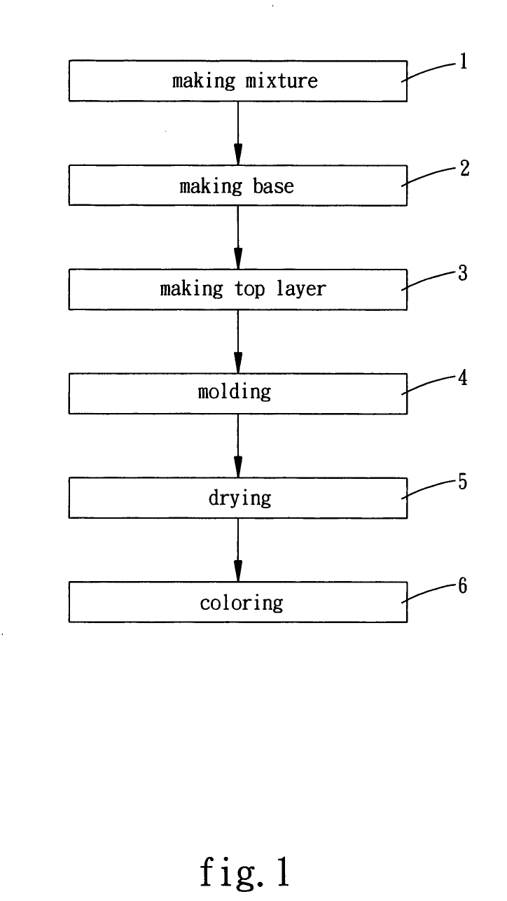

Referring to FIG. 1, the method for making decoration boards of the present invention comprises the following steps:

a step (1) of making mixture: mixing magnesium chloride and water to form a first mixture;

a step (2) of making base: mixing magnesium, the first mixture and water-based foaming agent to form a second mixture which is used as a base;

a step (3) of making top layer: mixing the magnesium and the first mixture to be a third mixture which is coated on the base;

a step (4) of molding: molding the base and the top layer in a mold to form patterns in the top layer;

a step (5) of drying: drying the molded base and the top layer to combine the molded base and the top layer, the water-based foaming agent being dried by form tiny holes, and

a step (6) of coloring: coloring the top layer.

The method allows the manufacturers to color the decoration boards with desired colors and the patterns of the decoration boards can be easily made by proper molds. The water-based foaming agent is easily dried to form tiny holes in the decoration boards such that the weight of the decoration boards is light.

While we have shown and described the embodiment in accordance with the present invention, it should be clear to those skilled in the art that further embodiments may be made without departing from the scope of the present invention.

What is claimed is:

1. A method for making decoration boards, comprising:
a step of making mixture: mixing magnesium chloride and water to form a first mixture;
a step of making base: mixing magnesium, the first mixture and water-based foaming agent to form a second mixture which is used as a base;
a step of making top layer: mixing the magnesium and the first mixture to be a third mixture which is coated on the base;
a step of molding: molding the base and the top layer in a mold to form patterns in the top layer;
a step of drying: drying the molded base and the top layer to combine the molded base and the top layer, the water-based foaming agent being dried by form tiny holes, and
a step of coloring: coloring the top layer.
